(19) United States
(12) Patent Application Publication
(10) Pub. No.: US 2019/0287449 A1
(43) Pub. Date: Sep. 19, 2019

(54) ASSEMBLIES OF ELECTRO-OPTIC DISPLAYS

(71) Applicant: E INK CORPORATION, Billerica, MA (US)

(72) Inventors: Rishik JARIWALA, Arlington, MA (US); Ying-Yung CHEN, Hsinchu (TW); Wei-Juin CHEN, Hsinchu (TW)

(21) Appl. No.: 16/354,376

(22) Filed: Mar. 15, 2019

Related U.S. Application Data
(60) Provisional application No. 62/643,802, filed on Mar. 16, 2018.

(51) Int. Cl. G09G 3/20; G09G 3/34

(52) U.S. Cl. CPC G09G 3/2085; G09G 2310/0264; G09G 2300/0439; G09G 3/3433

(57) ABSTRACT

An assembly including a plurality of separate and independently controllable electro-optic displays is provided. The electro-optic displays may be arranged to form the shape of an alpha-numeric character in an installed condition. The assembly may also include a substrate having a surface with an opaque area and a plurality of light-transmissive areas. The electro-optic displays may be arranged, such that each of the electro-optic displays is in register with one of the light-transmissive areas and the opaque area is optically coupled to the plurality of separate and independently controllable electro-optic displays.

### CROSS-REFERENCE TO RELATED APPLICATION

This application claims the benefit of and priority to U.S. Provisional Application No. 62/643,802 filed on Mar. 16, 2018, the content of which is incorporated by reference herein in its entirety.

### BACKGROUND

This invention relates to/electro-optic displays. More specifically, in one aspect this invention relates to assemblies in the form of alpha-numeric characters comprising a plurality of electro-optic displays and methods of making the same.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence, or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18 (3), 24 (March 2002). See also Bach, U., et al., Adv. Mater., 2002, 14 (11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT), E Ink Corporation, E Ink California, LLC and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:

(a) Electrophoretic particles, fluids and fluid additives; see for example U.S. Pat. Nos. 7,002,728 and 7,679,814;

(b) Capsules, binders and encapsulation processes; see for example U.S. Pat. Nos. 6,922,276 and 7,411,719;

(c) Microcell structures, wall materials, and methods of forming microcells; see for example U.S. Pat. Nos. 7,072,095 and 9,279,906;

(d) Methods for filling and sealing microcells; see for example U.S. Pat. Nos. 7,144,942 and 7,715,088;

(e) Films and sub-assemblies containing electro-optic materials; see for example U.S. Pat. Nos. 6,982,178 and 7,839,564;

(f) Backplanes, adhesive layers and other auxiliary layers and methods used in displays; see for example U.S. Pat. Nos. 7,116,318 and 7,535,624;

(g) Color formation and color adjustment; see for example U.S. Pat. Nos. 7,075,502 and 7,839,564;

(h) Methods for driving displays; see for example U.S. Pat. Nos. 7,012,600 and 7,453,445;

(i) Applications of displays; see for example U.S. Pat. Nos. 7,312,784 and 8,009,348; and

(j) Non-electrophoretic displays, as described in U.S. Pat. No. 6,241,921 and U.S. Patent Application Publication No. 2015/0277160; and applications of encapsulation and microcell technology other than displays; see for example U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display.

One of the applications for electrophoretic displays includes signage. For example, referring to FIG. 1, a design pattern 10 for one of the electrode layers of an electrophoretic display is illustrated in which the pattern 10 provides a clock sign. The clock sign may be used to display the start of a performance, for example. The design pattern 10 is divided into a plurality of variously shaped areas of conductive material. Each area defines a “pixel”. A single layer of electrophoretic material is applied over the pattern 10, and a different voltage may be applied to each pixel in order to switch the optical state of the electrophoretic media within the boundary of each pixel. However, the pattern 10 includes a plurality of areas 14 that will never change colors during operation, unlike the plurality of areas 12 that may periodically change over time. Therefore, the conductive material within areas 14 and the electrophoretic material applied over areas 14 are essentially wasted, which may comprise a majority of the overall display area and unnecessarily increases the cost of the display.

Accordingly, there is a need for improved electro-optic displays that reduce or eliminate conductive material and electro-optic material within areas of a display that are likely to remain in a constant optical state during operation of the display.

### SUMMARY

According to one aspect, an assembly may comprise a plurality of separate and independently controllable electro-optic displays being arranged to form the shape of an alpha-numeric character in an installed condition.

According to another aspect, an assembly may comprise a substrate and a plurality of separate and independently controllable electro-optic displays. The substrate may include a surface comprising an opaque area and a plurality of light-transmissive areas, wherein each of the electro-optic displays is in register with one of the light-transmissive areas and the opaque area is optically coupled to the plurality of separate and independently controllable electro-optic displays.

These and other aspects of the present invention will be apparent in view of the following description.

### BRIEF DESCRIPTION OF THE FIGURES

The drawing Figures depict one or more implementations in accord with the present concepts, by way of example only, not by way of limitations. The drawings are not to scale. In the figures, like reference numerals refer to the same or similar elements.

FIG. 1 is an example of an electrode design pattern that may be used in an electro-optic display found in the prior art.

FIG. 2A is a front plan view of a light-transmissive substrate that may be included in a first embodiment of the present invention.

FIG. 2B is a front plan view of the light-transmissive substrate of FIG. 2A coated with a colored pigment.

FIG. 2C is a rear plan view of the light-transmissive substrate of FIG. 2A with a plurality of electro-optic displays arranged on the rear surface of the substrate.

FIG. 2D is a front plan view of the light-transmissive substrate and electro-optic displays of FIG. 2C displaying a number “8.”

FIG. 2E is a front plan view of the light-transmissive substrate and electro-optic displays of FIG. 2C displaying a number “4.”

FIG. 3 is a cross-sectional view of the first embodiment along axis I-I in FIG. 2E.

FIG. 4 is a top plan view of a backplane for a first display included in a second embodiment of the present invention.

FIG. 5A is a top plan view of a backplane for a second display included in a second embodiment of the present invention.

FIG. 5B is a top plan view of a modified version of the backplane illustrated in FIG. 5A.

FIG. 6 is a top plan view of an assembly of the first and second displays of FIGS. 5 and 6.

FIG. 7 is a top plan view of a plurality of the assemblies of FIG. 6.

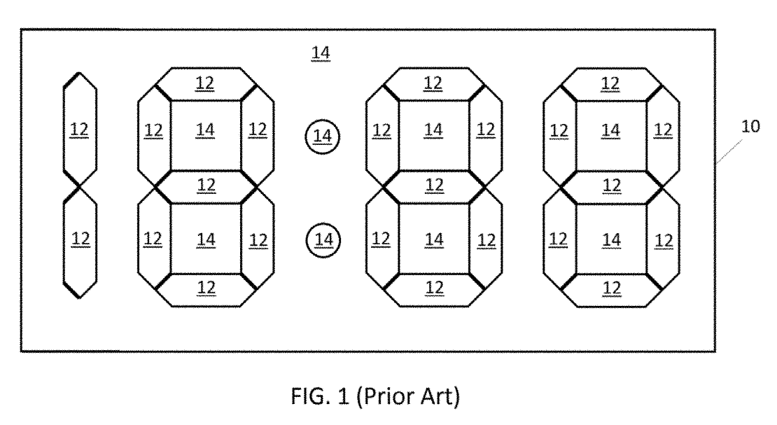

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details.

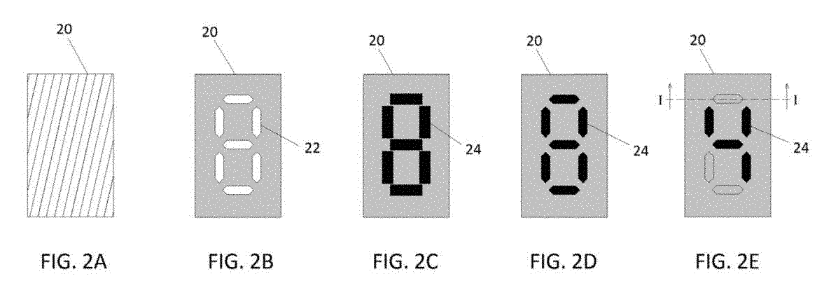

Assemblies made according to the various embodiments of the present invention may comprise a plurality of electro-optic displays arranged in the form of an alpha-numeric character. For example, referring to FIGS. 2A to 2E, a plurality of electro-optic displays 24 may be arranged on one side of a substrate 20. The electro-optic displays may be capable of switching between two optical states, such as black and gray, for example. The substrate 20 may be provided in the form of a light-transmissive panel, as illustrated in FIG. 2A, that is coated on at least one side with a substantially opaque ink or paint, as illustrated in FIG. 2B. The ink or paint is preferably optically coupled to one of the optical states of the electro-optic displays. As used herein “optically coupled” with reference to the substrate means exhibiting an optical state similar to at least one of the optical states of the electro-optic displays. For example, if the electro-optic displays switch between black and gray, the substrate 20 may be coated with a black pigment or a gray pigment, so that the permanent optical state of the substrate 20 is similar to one of the optical states of the electro-optic displays 24.

When coating the substrate 20 with the ink or paint, a plurality of areas 22 are left uncoated, such that they remain light-transmissive, as illustrated in FIG. 2B. In an alternative embodiment, the substrate 20 may be provided in the form of an opaque sheet, and the plurality of areas 22 may be obtained by removing sections to form windows or apertures in the opaque sheet. Again the optical state of the opaque sheet is preferably similar to one of the optical states of the electro-optic displays 24.

Referring to FIG. 2C, the plurality of electro-optic displays 24 are arranged on one side of the substrate 20, such that each display is in register with only one of the plurality of light-transmissive areas 22. In other words, each window is paired or associated with a single display. It is preferred that the area of the light-transmissive area is at least 70% of the display area of the electro-optic display with which it is registered, more preferably at least 80%, and most preferably at least 90%. The electro-optic displays may be affixed using any means known in the art, such as a fastener or an adhesive. As illustrated in FIGS. 2D and 2E, each one of the separate electro-optic displays may be independently controlled in order to change the image displayed on the front of the overall assembly. The displays may be operatively connected to at least one controller and/or at least one power source (not shown). The assembly may further comprise a rear panel (not shown) in order to house one or more of the plurality of displays, controllers, and power sources, and the front substrate may serve as a cover for the housing, for example.

In an alternative embodiment, the plurality of electro-optic displays may be arranged on the front surface of a substrate having an optical state that is similar to one of the optical states of the electro-optic displays. In this embodiment, the plurality of light-transmissive areas are unnecessary, and the embodiment may further comprises some masking material around the edges of the electro-optic displays, so that the appearance of the displays blends with the surrounding area. The masking material may include, but is not limited to, an ink, paint, or colored tape. The appearance of the masking material may be similar to the optical state of the front surface of the substrate.

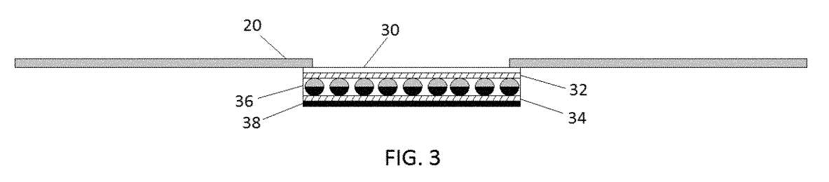

Each one of the electro-optic displays included in the assemblies according to the various embodiments of the present invention may include a plurality of layers. As illustrated in FIG. 3, for example, each electro-optic display may comprise, in order, a light-transmissive protective layer 20, a front light-transmissive layer of conductive material 32, a layer of electro-optic media 36, a rear layer of conductive material 34, and a rear substrate 38. One of the front and rear layers of conductive material may be absent in some embodiments.

The rear substrate 38 and rear layer of conductive material 34 together may form what is commonly known in the industry as a “backplane.” The rear substrate 38 may be formed from an ablatable polymeric material, such as a polyimide, for example. The substrate may also include other optional layers such as a reflective/moisture barrier. Any method known by those of skill in the art may be used to fabricate a backplane for use in the various embodiments made according to the present invention, such as U.S. Pat. No. 7,223,672.

There are three main categories of backplanes: an active matrix, a passive matrix, and a direct drive backplane. Any type of backplane may be used in the various embodiments of the present invention; however, direct drive backplanes are preferred. For an active matrix backplane, an array of thin film transistors (TFT) are formed on the surface of a substrate and each transistor acts as a switch for a pixel. Passive-matrix backplanes use a simple grid to supply the charge to a particular pixel on the display. The grids are formed on top and the bottom of substrates. In a direct-drive backplane, the rear substrate may include an electrical connector located on an edge of the substrate that is electrically connected to the layer(s) of conductive material, which serves as the pixel electrode.

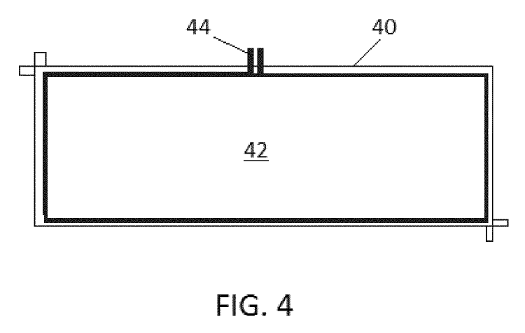

In a preferred embodiment of the present invention, the plurality of electro-optic displays included in the assembly may include a first display and a second display. The first display may include a direct-drive backplane in the form of a rectangular area, as illustrated in FIG. 4, for example. The backplane may include a rear substrate 40 on which a layer of conductive material 42 is applied, as well as a connector 44. Prior to applying the layer of conductive material 42, a conductive trace (not shown) may be applied to the surface of the rear substrate 40 that leads to the connector 44. The conductive trace functions to electrically connect the conductive material 42 to the connector 44. The rectangular area formed by the layer of conductive material 42 is not segmented; therefore, the entire area behaves as a single pixel. The second display may include a segmented backplane and a majority of the display area is dynamic. As used herein “dynamic” means that the conductive material is likely to switch the electro-optic media during operation of the display.

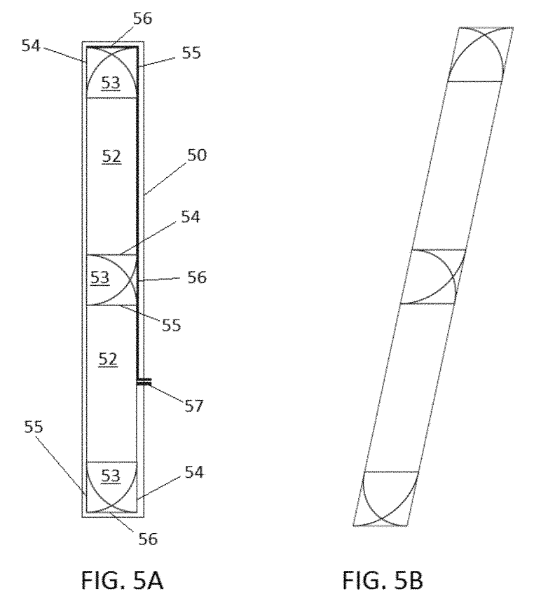

In one embodiment, the second segmented backplane may have an electrode design pattern as illustrated in FIG. 5A having a plurality of pixel electrodes. The second display may comprise a rear substrate 50 and a plurality of conductive traces (not shown) applied to the surface of the rear substrate 50, wherein each trace has a conductor at one end that will be associated with a respective pixel electrode and the opposite end of the trace is connected to a connector 57. A layer of insulating material may then be coated onto the rear substrate 50. The insulating layer is preferably made from a dielectric material, such as silicon nitride, an insulating polymer, or cross-linkable monomer or oligomer. The insulating layer is applied to cover the traces, while leaving the end portions, including the conductors, exposed. The segmented pattern of conductive material forming the pixel electrodes 52, 53, 54, 55, 56 is then printed onto the insulating material, such that each segment is electrically connected to a respective conductor. In an alternative embodiment, the second segmented backplane illustrated in FIG. 5A may be slightly modified, such that an oblique version of the segmented electrode pattern as illustrated in FIG. 5B is provided on the backplane. In FIGS. 5A and 5B, the boundaries between the different areas of conductive material forming the pixel electrodes 52, 53, 54, 55, 56 comprise the insulating material.

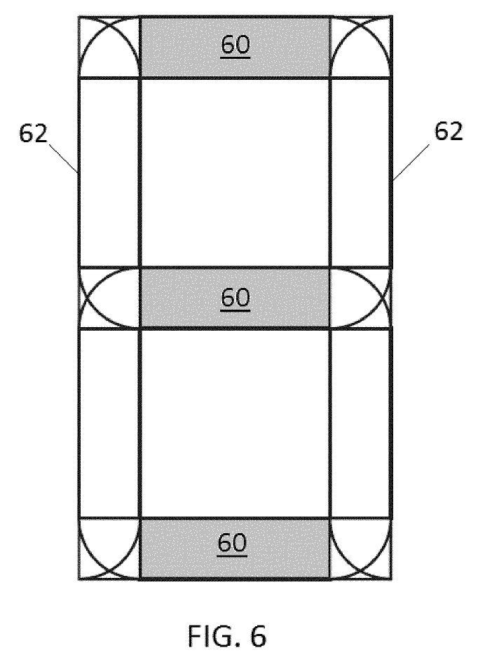

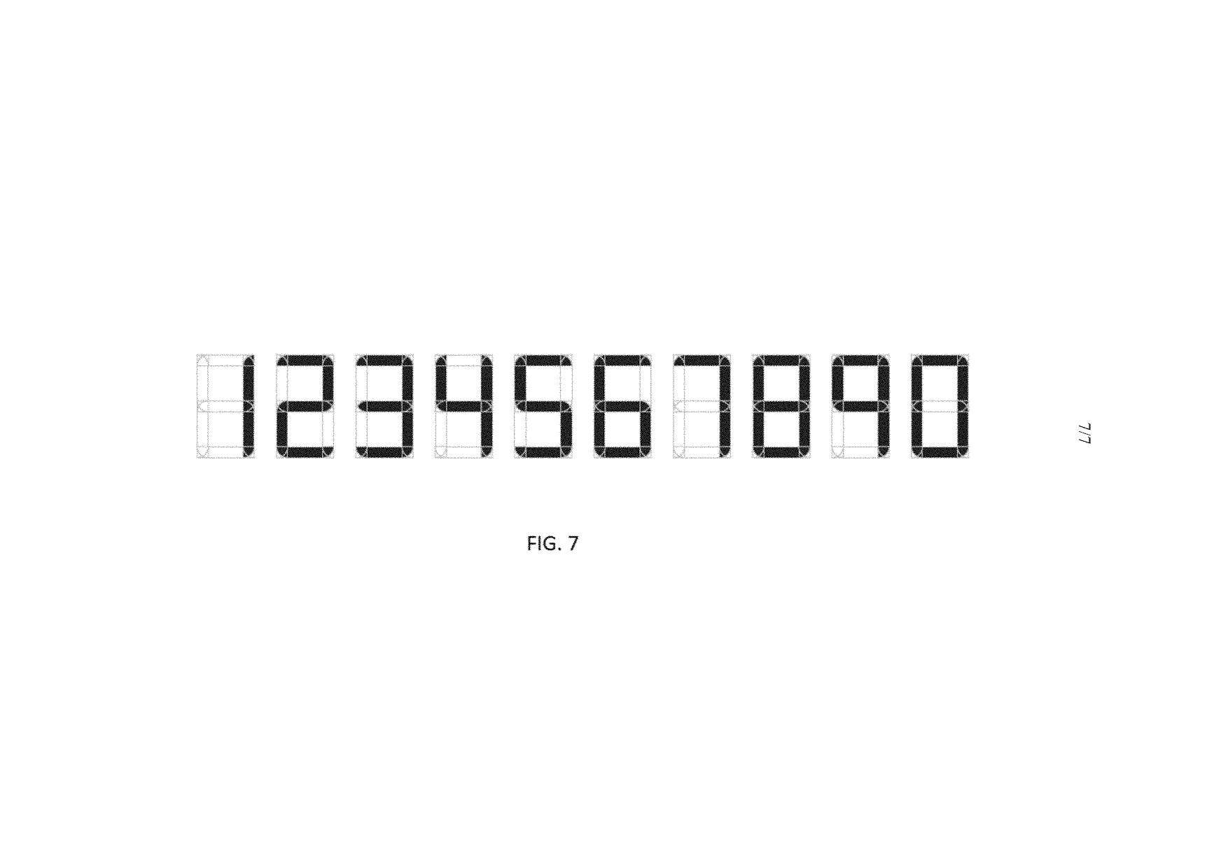

The pattern of the pixel electrodes of the second display illustrated in FIG. 5A may include two rectangular areas 52 having an area equal to the area of the pixel electrode of the first display illustrated in FIG. 4. The pattern of the pixel electrodes of the second display may also include three square-shaped areas containing four distinct pixel electrodes, such that the overall pattern of the pixel electrodes on the backplane is symmetrical. By providing a symmetrical pattern, manufacturing of the assembly may be simplified because only two types of displays are required to form an alpha-numeric character. For example, referring to FIG. 6, the combination of only three displays 60 having a backplane as illustrated in FIG. 4 and two displays 62 having a backplane as illustrated in FIG. 5A may be arranged to form an alpha-numeric character, e.g. the number “8.” As a result, a majority of the display area of the assembly is dynamic; thereby, reducing the amount of conductive material and electro-optic media needed to construct the display. If a display having an electrode pattern illustrated in FIG. 5B were included in an assembly according to the invention, the displays having a backplane, such as those illustrated in FIG. 4 may be similarly modified into an oblique shape, e.g. a parallelogram, so that the displays may be arranged into an alpha-numeric character.

The assemblies made according to the various embodiments of the present invention also enable the construction of large electro-optic displays, specifically electrophoretic displays. For example, the overall assemblies may have a lateral dimension of at least 20 cm, more preferably at least 50 cm, and most preferably at least 1 m.

The electro-optic displays used in the various embodiments of the present invention may include any type of electro-optic media. The electro-optic media is preferably bistable and is most preferably electrophoretic media.

The manufacture of an electrophoretic display incorporated in the various embodiments of the present invention normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane, containing one or more pixel electrodes and an appropriate arrangement of conductors to connect the pixel electrodes to drive circuitry, is prepared. To form the final display, the substrate having the capsule/binder layer thereon is laminated to the backplane using a lamination adhesive. (In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. (Variants of the FPL include a so-called “double release sheet” described in U.S. Pat. No. 7,561,324 and a so-called “inverted front plane laminate” described in U.S. Pat. No. 7,839,564.)

Typically, a light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trade Mark) from E.I. du Pont de Nemours & Company, Wilmington Del., and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

Electro-optic displays manufactured using the aforementioned front plane laminates or double release films normally have a layer of lamination adhesive between the electro-optic layer itself and the backplane, for example, and the presence of this lamination adhesive layer affects the electro-optic characteristics of the displays. In particular, the electrical conductivity of the lamination adhesive layer affects both the low temperature performance and the resolution of the display. The low temperature performance of the display can (it has been found empirically) be improved by increasing the conductivity of the lamination adhesive layer, for example by doping the layer with tetrabutylammonium hexafluorophosphate or other materials as described in U.S. Pat. Nos. 7,012,735 and 7,173,752.

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

All of the contents of the aforementioned patents and applications are incorporated by reference herein in their entireties.

We claim:

1. An assembly comprising a plurality of separate and independently controllable electro-optic displays being arranged to form the shape of an alpha-numeric character in an installed condition.

2. The assembly of claim 1, wherein the plurality of electro-optic displays comprise at least one display having a single pixel electrode.

3. The assembly of claim 2, wherein the plurality of electro-optic displays further comprises at least one display having a plurality of segmented pixel electrodes.

4. The assembly of claim 3, wherein at least one of the segmented pixel electrodes has an area equal to the single pixel electrode.

5. The assembly of claim 1, wherein at least one of the plurality of separate and independently controllable electro-optic displays comprises a layer of electrophoretic material, the electrophoretic material comprising an encapsulated dispersion of charged pigment particles.

6. The assembly of claim 5, wherein the charged pigment particles comprise a first set of particles having a first color and a second set of particles having a second color, wherein the first and second color differ.

7. The assembly of claim 6 further comprising a substrate and the plurality of separate and independently controllable electro-optic displays are arranged on a surface of the substrate.

8. The assembly of claim 7, wherein the substrate comprises a plurality of light-transmissive areas and each of the separate and independently controllable electro-optic displays is in register with only one of the light-transmissive areas.

9. The assembly of claim 7, wherein the substrate is optically coupled to the plurality of electro-optic displays.

10. The assembly of claim 1, wherein each of the separate and independently controllable electro-optic displays has a lateral dimension greater than or equal to 20 centimeters.

11. The assembly of claim 10, wherein each of the separate and independently controllable electro-optic displays has a lateral dimension greater than or equal to 1 meter.

12. The assembly of claim 10, wherein each of the separate and independently controllable electro-optic displays has only a single pixel electrode configured to control an optical state of the display.

13. A system comprising an assembly of claim 1 and a controller operatively connected to each of the separate and independently controllable electro-optic displays.

14. An assembly comprising:
a substrate having a surface comprising an opaque area and a plurality of light-transmissive areas; and
a plurality of separate and independently controllable electro-optic displays, wherein each of the electro-optic displays is in register with one of the light-transmissive areas.

15. The assembly of claim 14, wherein the plurality of electro-optic displays comprise at least one display having a single pixel electrode.

16. The assembly of claim 15, wherein the plurality of electro-optic displays further comprises at least one display having a plurality of segmented pixel electrodes.

17. The assembly of claim 16, wherein at least one of the segmented pixel electrodes has an area equal to the single pixel electrode.

18. The assembly of claim 14, wherein at least one of the plurality of separate and independently controllable electro-optic displays comprises a layer of electrophoretic material, the electrophoretic material comprising an encapsulated dispersion of charged pigment particles.

19. The assembly of claim 18, wherein the charged pigment particles comprise a first set of particles having a first color and a second set of particles having a second color, wherein the first and second color differ.

20. The assembly of claim 19, wherein the opaque area is optically coupled to the plurality of electro-optic displays.
